(19) United States
(12) Patent Application Publication
(10) Pub. No.: US 2011/0225071 A1
(43) Pub. Date: Sep. 15, 2011

(54) INFORMATION PROCESSING APPARATUS, INFORMATION DISPLAY APPARATUS, AND DISPLAY CONTROL METHOD

(75) Inventor: Takeshi Sano, Shizuoka (JP)

(73) Assignee: TOSHIBA TEC KABUSHIKI KAISHA, Tokyo (JP)

(21) Appl. No.: 13/038,678

(22) Filed: Mar. 2, 2011

(30) Foreign Application Priority Data
Mar. 10, 2010 (JP) 2010-053828

(51) Int. Cl. G06Q 10/00

(52) U.S. Cl. 705/28

(57) ABSTRACT

According to one embodiment, an information processing apparatus includes an input unit, a generating unit, and a transmitting unit. The input unit receives input of receipt time information of a commodity. The generating unit generates, according to the receipt time information input to the input unit, commodity information concerning the commodity including at least one of receipt date and time information and display date and time information of the commodity. The transmitting unit transmits the commodity information generated by the generating unit to an information display apparatus.

### CROSS-REFERENCE TO RELATED APPLICATION

This application is based upon and claims the benefit of priority from the prior Japanese Patent Application No. 2010-053828, filed on Mar. 10, 2010; the entire contents of which are incorporated herein by reference.

### FIELD

Embodiments described herein relate generally to an information processing apparatus, an information display apparatus, and display control method.

### BACKGROUND

In the past, in stores selling commodities such as a supermarket and a convenience store, when commodities displayed on shelves or the like are sold out, paper tags on which character information such as “sold out” and “receipt scheduled date” is described are set in display places where the commodities sold out (hereinafter simply also referred to as “sold-out commodities” were displayed.

In the past, a price tag display (see, for example, Japanese Patent Application Laid-open No. H05-134635) is known. The price tag display is set in the stores and displays messages such as “sold out soon” and “date of next warehousing” besides general commodity information such as commodity names and prices.

Therefore, in the past, customers can check warehousing (hereinafter referred to as “receipt”) of sold-out commodities by looking at the character information such as “receipt scheduled date” of the paper tags and the messages such as “date of next warehousing” displayed on the price tag display.

### DESCRIPTION OF THE DRAWINGS

FIG. 1 is a schematic diagram of a schematic configuration of a commodity-information presenting system according to an embodiment;

FIG. 2 is a perspective view of an external configuration of an electronic inventory tag terminal according to the embodiment;

FIG. 3 is a block diagram of a hardware configuration of a head office server according to the embodiment;

FIG. 4 is a block diagram of a hardware configuration of a store server according to the embodiment;

FIG. 5 is a block diagram of a hardware configuration of an electronic-inventory-tag management server according to the embodiment;

FIG. 6 is a block diagram of a hardware configuration of the electronic inventory tag terminal according to the embodiment;

FIG. 7 is a block diagram of a hardware configuration of a vehicle-information transmitting apparatus according to the embodiment;

FIG. 8 is a block diagram of a functional configuration in the commodity-information presenting system according to the embodiment;

FIG. 9 is a diagram of a structure example of a delivery-vehicle management table stored in a delivery-vehicle-information updating unit according to the embodiment;

FIG. 10A is a diagram of a structure example of a past-result-display-time management table stored in a display-scheduled-time calculating unit according to the embodiment;

FIG. 10B is a diagram of a structure example of a display-scheduled-time management table stored in a display-scheduled-time updating unit according to the embodiment;

FIG. 11 is a diagram of a structure example of a sold-out-commodity management table stored in a sold-out-commodity specifying unit according to the embodiment;

FIG. 12 is a sequence chart for explaining a flow of processing in the commodity-information presenting system according to the embodiment;

FIG. 13 is a flowchart for explaining a flow of processing performed in a delivery-vehicle managing unit of the head office server shown in FIG. 12;

FIG. 14 is a flowchart for explaining a flow of processing performed in an arrival-scheduled-time relay unit of the store server;

FIG. 15 is a flowchart for explaining a flow of processing performed by a display-scheduled-time managing unit of the electronic-inventory-tag management server shown in FIG. 12; and

FIG. 16 is a flowchart for explaining a flow of processing performed by a display-date-and-time-display processing unit of the electronic inventory tag terminal shown in FIG. 12.

### DETAILED DESCRIPTION

In the price tag display in the past, although a message indicating “date of next receipt” set in advance is displayed, a message indicating what time a sold-out commodity is received, a message indicating what time the sold-out commodity is displayed, and the like are not displayed. Therefore, customers cannot learn around what time in the date of next receipt the sold-out commodity is displayed and the customers can actually purchase the sold-out commodity.

Therefore, most customers go to other stores to find the sold-out commodity without waiting for the date of receipt. As a result, for the store side, there are inconveniences such as a loss of sales opportunities and a decrease in operating income of the store.

An embodiment appropriately presents receipt date and time information and display date and time information of commodities to customers.

In general, according to one embodiment, an information processing apparatus includes an input unit, a generating unit, and a transmitting unit. The input unit receives input of receipt time information of a commodity. The generating unit generates, according to the receipt time information input to the input unit, commodity information concerning the commodity including at least one of receipt date and time information and display date and time information of the commodity. The transmitting unit transmits the commodity information generated by the generating unit to an information display apparatus.

The embodiment is explained below with reference to the accompanying drawings.

In the following explanation of the embodiment, the embodiment is applied to, in a store such as a convenience store, a commodity-information presenting system including an electronic inventory tag terminal set near a commodity associated with the electronic inventory tag terminal and configured to display information about the commodity and an electronic-inventory-tag management server configured to manage the display by the electronic inventory tag terminal.

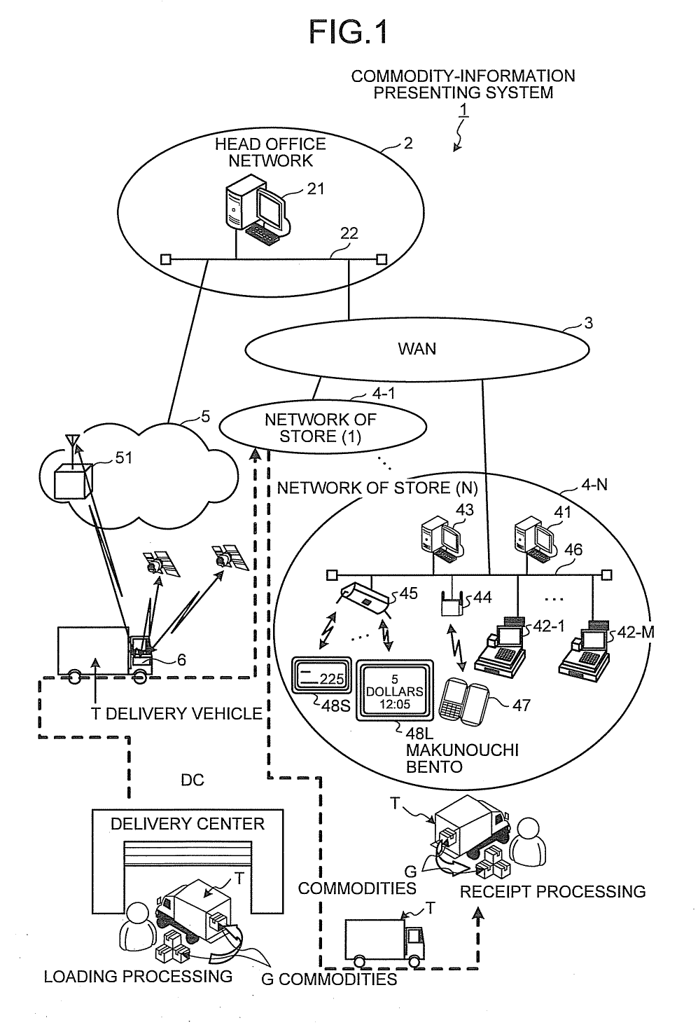

As shown in FIG. 1, this commodity-information presenting system 1 mainly includes a head office network 2 and plural store networks 4-1 to 4-N (N is an arbitrary integer) communication-connected to the head office network 2 via an external network 3. The external network 3 includes a network such as a wide area network (WAN) or a virtual private network (VPN).

In the head office network 2, a head office server 21 and various not-shown apparatuses such as a router and a printer are communication-connected via an internal network 22. The internal network 22 includes a network such as a local area network (LAN).

The head office server 21 is a server apparatus set in a head office that collectively manages stores (1) to (N) (N is an arbitrary integer) and serving as a host apparatus of store servers 41 set in the stores (1) to (N).

In each of the store networks 4-1 to 4-N, the store server 41, plural POS terminals 42-1 to 42-M (M is an arbitrary integer), an electronic-inventory-tag management server 43, a radio access point 44, a radio repeater 45, and the like are communication-connected via an internal network 46. A handy terminal 47 is communication-connected to the internal network 46 via the radio access point 44. Electronic inventory tag terminals 48 (48L and 48S) are communication-connected to the internal network 46 via the radio repeater 45. The internal network 46 includes a network such as a LAN.

Scanner apparatuses (not shown) as code reading apparatuses configured to read codes such as barcodes attached to commodities G and acquire commodity codes are respectively communication-connected to the POS terminals 42-1 to 42-M.

The store server 41 is a server apparatus set in, for example, a backyard of a convenience store and serving as a host apparatus of the POS terminals 42, the electronic-inventory-tag management server 43, and the like and mainly performs registration and settlement of commodities purchased by customers between the store server 41 and the POS terminals 42. The store server 41 also gives, for example, a rewriting instruction for display content to the electronic inventory tag terminals 48 via the electronic-inventory-tag management server 43.

The POS terminals 42 are set in settlement places in the store and perform, on the basis of commodity codes received from the scanner apparatuses forming pairs with the POS terminals 42, registration and settlement of commodities purchased by customers between the POS terminals 42 and the store server 41.

The electronic-inventory-tag management server 43 is a server apparatus serving as a host apparatus of the plural electronic inventory tag terminals 48 (48L and 48S) and manages information displayed in the electronic inventory tag terminals 48.

The radio access point 44 is an apparatus for communication-connecting the store server 41 or the electronic-inventory-tag management server 43 and the handy terminal 47. The radio access point 44 performs protocol conversion between a radio LAN and a wire LAN.

The radio repeater 45 is an apparatus set on, for example, the ceiling of the store and for communication-connecting the electronic-inventory-tag management server 43 and the electronic inventory tag terminals 48 (48L and 48S) . The radio repeater 45 performs protocol conversion between the radio LAN and the wire LAN.

The handy terminal 47 is a portable information terminal carried by a store clerk and is used when the store clerk inputs inspection data of commodities in the backyard. The handy terminal 47 is used when ID barcodes of the electronic inventory tag terminals 48 read by the handy terminal 47 and barcodes of the commodities G are tied.

The plural electronic inventory tag terminals 48 (48L and 48S) are arranged to be dispersed in the store. Specifically, the electronic inventory tag terminals 48 are set near commodities associated therewith and present commodity information concerning the associated commodities to customers and store clerks. The commodity information includes display scheduled date and time information peculiar to this embodiment besides general commodity information such as commodity names, prices, contents, and barcodes.

The plural electronic inventory tag terminals 48 include a large electronic inventory tag terminal (commonly called ESL terminal) 48L having a large screen size and a small electronic inventory tag terminal (commonly called POS terminal) 48S having a small screen size. In the following explanation, an unspecified electronic inventory tag terminal is simply referred to as the electronic inventory tag terminal 48.

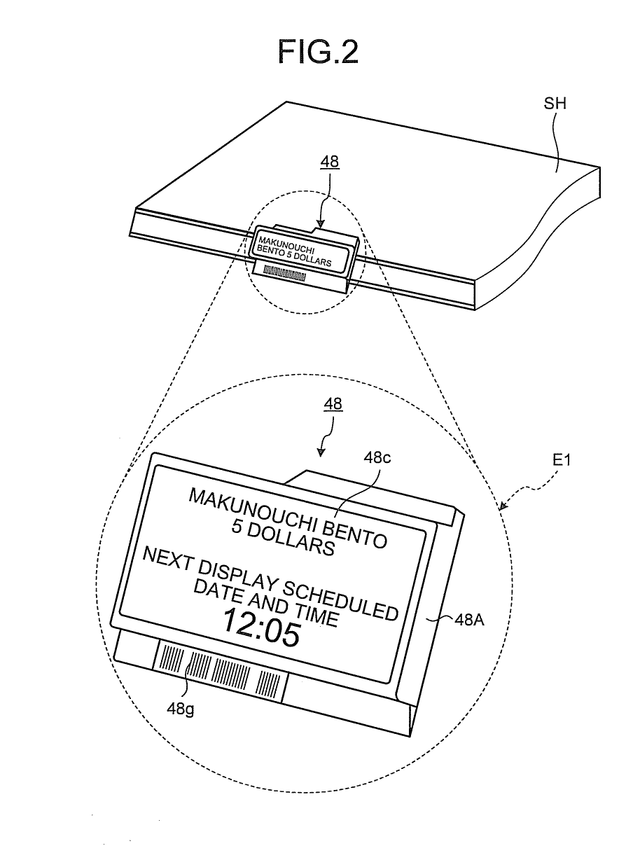

As shown in FIG. 2, the electronic inventory tag terminal 48 is set in, for example, the front edge of a shelf SH. As shown in an enlarged view of a sign E1, the electronic inventory tag terminal 48 has a housing 48A of a thin plate shape, i.e., a label shape. The housing 48A includes, on the front side thereof, a display unit 48c configured to display information concerning the commodities G associated with the electronic inventory tag terminal 48 and a terminal code unit 48g indicating an ID barcode of the electronic inventory tag terminal 48.

The electronic inventory tag terminal 48 according to this embodiment displays information indicating display date and time when the commodity associated with the electronic inventory tag terminal 48 is displayed next (hereinafter referred to as “display scheduled date and time information”) besides displaying general commodity information indicating a commodity name, a price, and the like of the associated commodity. In an example shown in FIG. 2, a state in which commodity name information “Makunouchi Bento”, price information “5 dollars”, and display scheduled date and time information “next display scheduled date and time 10 12:05” are displayed is shown.

In the commodity-information presenting system 1 according to this embodiment, vehicle-information transmitting apparatuses 6 mounted on delivery vehicles T are communication-connected to the head office network 2 via a predetermined communication network 5. The predetermined communication network 5 is a network including a radio base station 51, various repeaters (not shown) such as an exchange, and a line (not shown).

The delivery vehicles T are vehicles such as trucks that deliver the commodities G loaded in a delivery center DC to the stores (1) to (N).

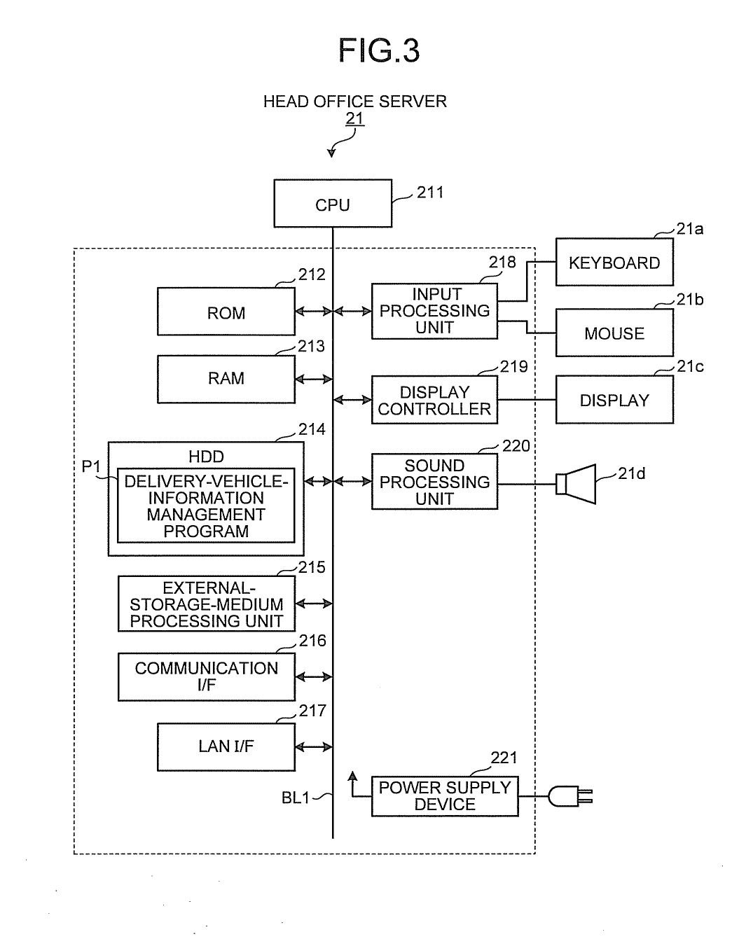

The head office server 21 has a hardware configuration including a general computer such as a personal computer. As shown in FIG. 3, the head office server 21 includes, for example, a central processing unit (CPU) 211 and a read only memory (ROM) 212, a random access memory (RAM) 213, a hard disk drive (HDD) 214, an external-storage-medium processing unit 215, a communication I/F 216, a LAN I/F 217, an input processing unit 218, a display controller 219, and a sound processing unit 220 connected to the CPU 211 via a bus line BL1. The head office server 21 also includes a power supply device 221.

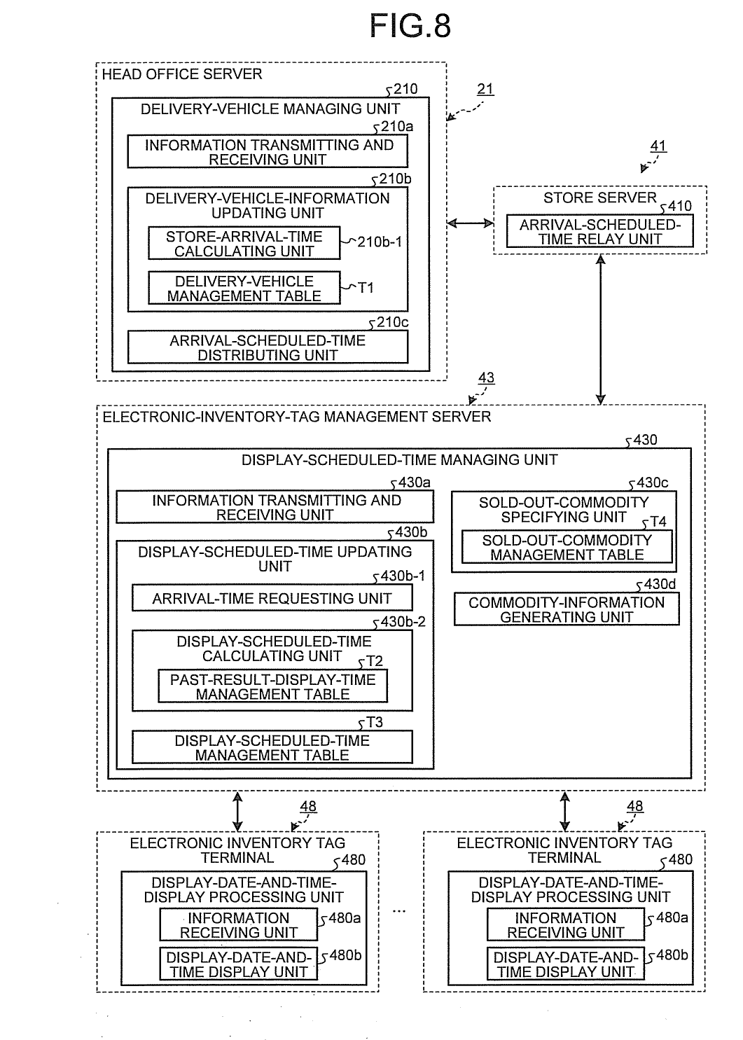

The CPU 211 controls the entire head office server 21, i.e., controls various arithmetic operations and various kinds of processing applied to the components. The ROM 212 or the HDD 214 stores various files of a control program and the like for executing various kinds of processing in the head office server 21. The HDD 214 according to this embodiment stores a delivery-vehicle-information management program P1 for executing a delivery-vehicle managing unit 210 (see FIG. 8) as a functional component explained later. The RAM 213 temporarily stores data during work such as input data and display data and temporarily stores the various files of the control program and the like read out from the ROM 212 or the HDD 214 during the start of the head office server 21.

The external-storage-medium processing unit 215 performs reading from and writing in an external recording medium such as a CD-RW.

The communication I/F 216 transmits various data to and receives various data from the store servers 41 of the stores connected via the external network 3. The LAN I/F 217 transmits various data to and receives various data from other apparatuses such as a printer (not shown) connected via the internal network 22.

The input processing unit 218 receives input of an operation signal from a keyboard 21a or a mouse 21b and outputs the input operation signal to the CPU 211. The display controller 219 controls screen display of a display 21c. The sound processing unit 220 causes a speaker 21d to emit various kinds of sound such as alarm sound.

When a plugging instrument such as a plug is connected to a commercial power supply such as a socket, the power supply device 221 converts voltage from the commercial power supply into DC voltage supplied to an internal circuit of the head office server 21 and outputs the DC voltage.

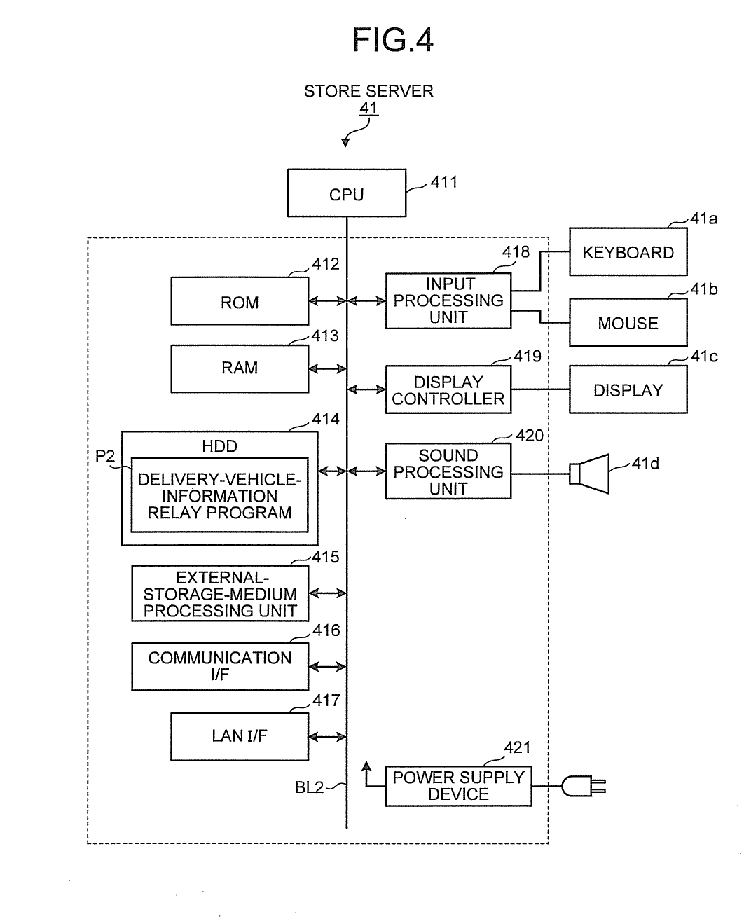

The store server 41 has a hardware configuration including a general computer such as a personal computer. As shown in FIG. 4, the store server 41 includes, for example, a CPU 411 and a ROM 412, a RAM 413, a HDD 414, an external-storage-medium processing unit 415, a communication I/F 416, a LAN I/F 417, an input processing unit 418, a display controller 419, and a sound processing unit 420 connected to the CPU 411 via a bus line BL2. The store server 41 also includes a power supply device 421.

Since the store server 41 has the hardware configuration same as that of the head office server 21, detailed explanation of the store server 41 is omitted. However, various files of a control program and the like stored in the ROM 412, the RAM 413, the HDD 414, and the like are different.

Specifically, in the store server 41, a commodity information file is stored in the HDD 414 or the like. The store server 41 returns necessary commodity information from the commodity information file according to inquiries from the POS terminals 42. The commodity information file is a file that stores, in association with each other, commodity codes for specifying commodities peculiarly allocated for each type of commodities and commodity information including names (commodity names) and unit prices of the commodities.

In the store server 41, a delivery-vehicle-information relay program P2 for executing an arrival-scheduled-time relay unit 410 (see FIG. 8) as a functional configuration explained later is stored in the HDD 414.

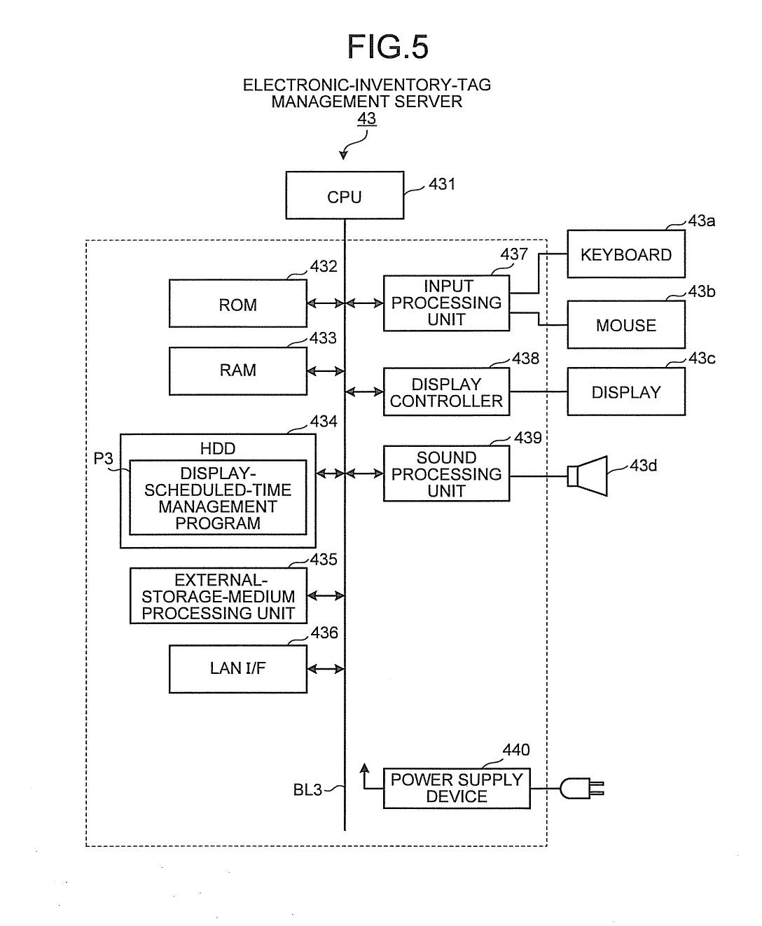

The electronic-inventory-tag management server 43 has a hardware configuration including a general computer such as a personal computer. As shown in FIG. 5, the electronic-inventory-tag management server 43 includes, for example, a CPU 431 and a ROM 432, a RAM 433, a hard disk device (HDD) 434, an external-storage-medium processing unit 435, a LAN I/F 436, an input processing unit 437, a display controller 438, and a sound processing unit 439 connected to the CPU 431 via a bus line BL 3. The electronic-inventory-tag management server 43 also includes a power supply device 440.

Since the electronic-inventory-tag management server 43 has a hardware configuration same as that of the head office server 21 and the store server 41, detailed explanation of the electronic-inventory-tag management server 43 is omitted. However, various files of a control program and the like stored in the ROM 432, the RAM 433, the HDD 434, and the like are different.

Specifically, in the electronic-inventory-tag management server 43, a display-scheduled-time management program P3 for executing a display-scheduled-time managing unit 430 (see FIG. 8) as a functional configuration explained later is stored in the HDD 434.

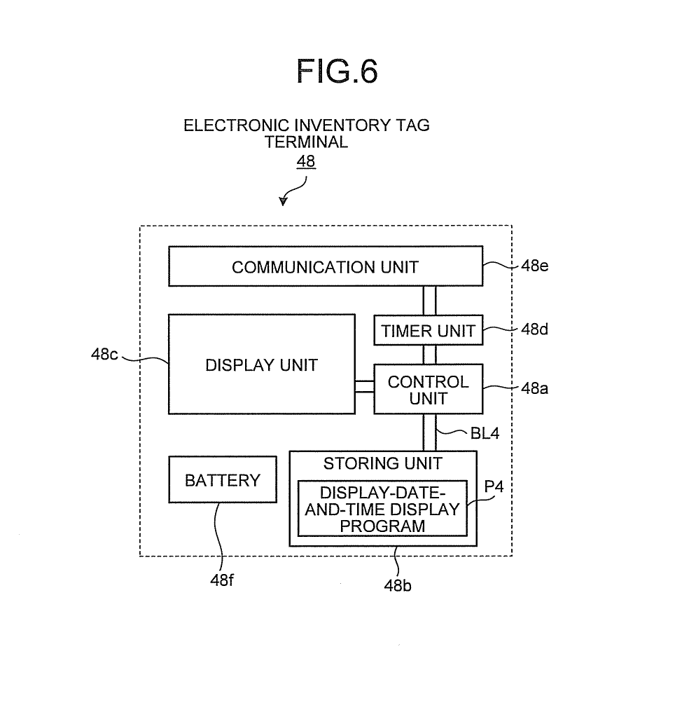

As shown in FIG. 6, the electronic inventory tag terminal 48 includes, for example, a control unit 48a and a storing unit 48b, a display unit 48c, a timer unit 48d, and a communication unit 48e connected to the control unit 48a via a bus line BL4. The electronic inventory tag terminal 48 also includes a battery 48f. The control unit 48a, the storing unit 48b, the display unit 48c, the timer unit 48d, and the communication unit 48e are realized by integrated circuits or the like. The display unit 48c is realized by dot matrix liquid crystal or the like.

The control unit 48a controls the entire electronic inventory tag terminal 48, i.e., controls various arithmetic operations and various kinds of processing applied to the components. The storing unit 48b is a nonvolatile memory configured to store various files of a control program and the like for executing various kinds of processing in the electronic inventory tag terminal 48.

The storing unit 48b according to this embodiment stores a display-date-and-time display program P4 for executing display-date-and-time-display processing units 480 (see FIG. 8) as functional components explained later.

The display unit 48c displays commodity information such as a commodity name, a price, and display scheduled date and time on the basis of commodity information received by the communication unit 48e. The timer unit 48d performs synchronization and time measurement during communication control. The communication unit 48e communicates with the radio repeater 45. The battery 48f is a driving source for supplying DC voltage to the circuit units 48a to 48e.

Both the large electronic inventory tag terminal 48L and the small electronic inventory tag terminal 48S have the hardware configuration explained above. However, the large electronic inventory tag terminal 48L and the small electronic inventory tag terminal 48S are difference in an external shape and screen size including the number of pixels of the display unit 48c, a storage capacity of the storing unit 48b, and the like.

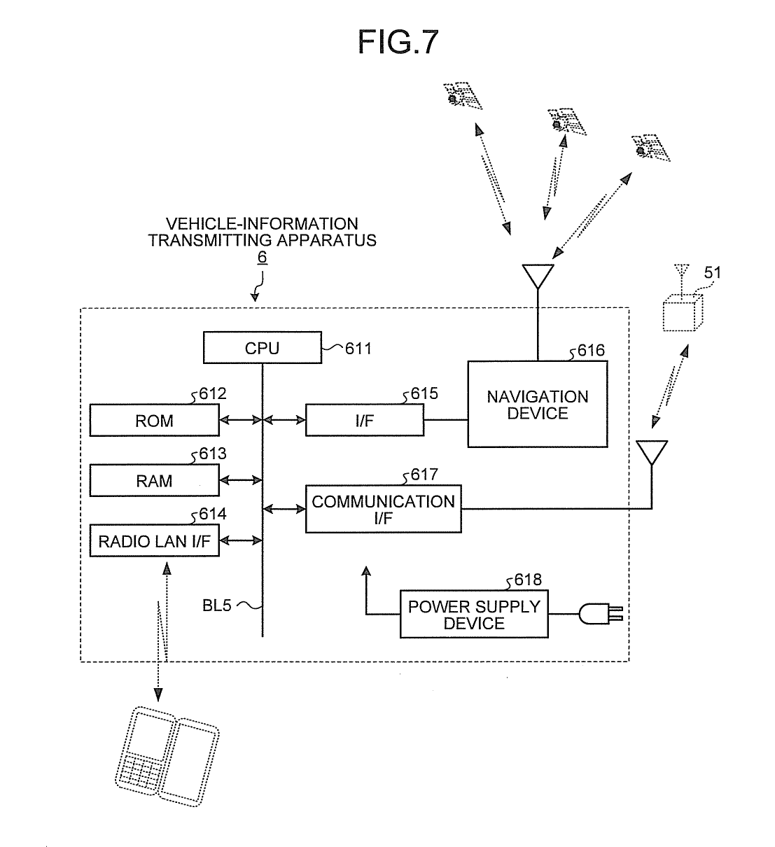

As shown in FIG. 7, the vehicle-information transmitting apparatus 6 includes, for example, a CPU 611 and a ROM 612, a RAM 613, a radio LAN I/F 614, an I/F 615, and a communication I/F 617 connected to the CPU 611 via a bus line BL5. The vehicle-information transmitting apparatus 6 also includes a navigation device 616 and a power supply device 618.

The CPU 611, the ROM 612, and the RAM 613 are respectively the same as the CPU 211, the ROM 212, and the RAM 213 mounted on the head office server 21.

The radio LAN I/F 614 transmits various data to and receives various data from a handy terminal (not shown) carried by, for example, a worker in the delivery center DC connected via a radio LAN or a driver of the delivery vehicle T. Specifically, the radio LAN I/F 614 receives, from the handy terminal, information concerning commodity codes as information concerning the commodities G loaded on the delivery vehicle T.

The I/F 615 transmits various data to and receives various data from the navigation device 616 connected via a predetermined signal line or the like. Specifically, the I/F 615 receives present location information of the delivery vehicle T from the navigation device 616.

The communication I/F 617 transmits various data to and receives various data from the predetermined communication network 5 communication-connected via a predetermined radio communication line. Specifically, the communication I/F 617 transmits, for example, the information concerning the commodity code of the commodity G and the present location information of the delivery vehicle T received by the radio LAN I/F 614 and the I/F 615 to the head office server 21.

The navigation device 616 is an electronic device that has a well-known satellite positioning system function such as the global positioning system (GPS) and receives a radio wave from an artificial satellite to specify the present location of the navigation device 616.

More specifically, the navigation device 616 has a hardware configuration same as a general car navigation device. For example, the navigation device 616 presents the present location of the delivery vehicle T to a person riding on the delivery vehicle T (the driver) and performs route guide to a destination on the basis of the acquired present location information using a display device (not shown) such as a liquid crystal display and an acoustic device (not shown) such as a speaker.

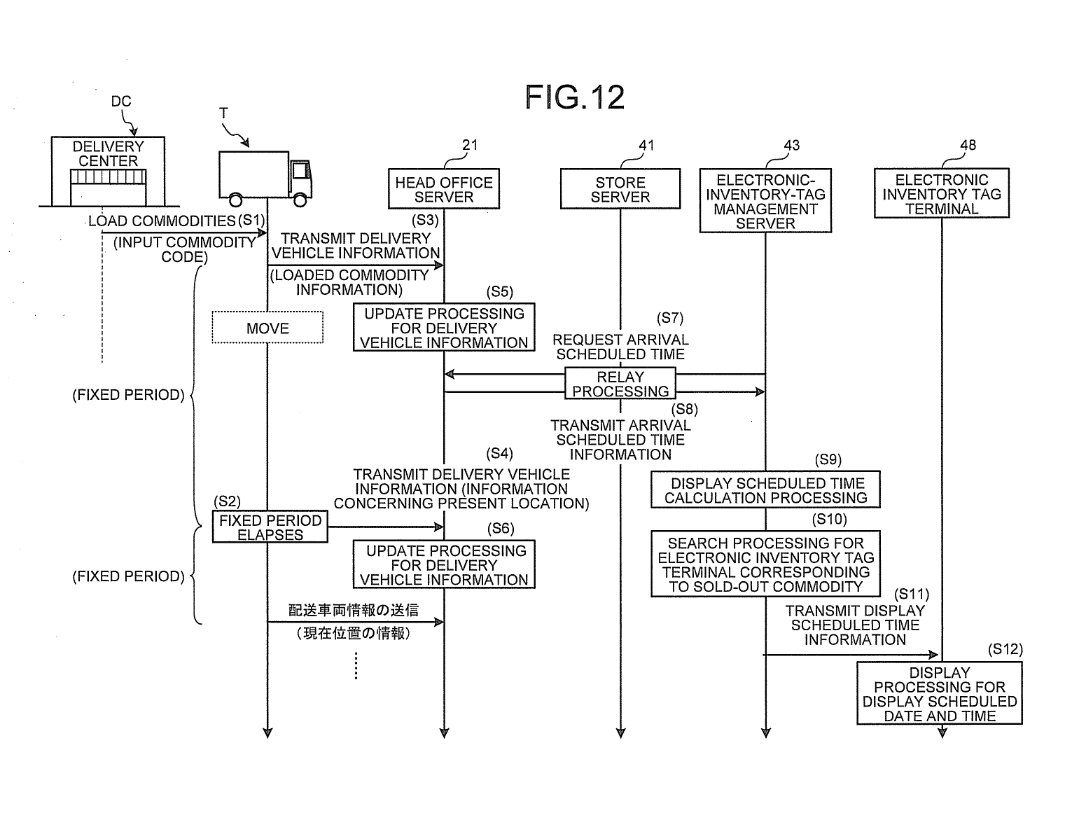

As shown in FIG. 8, in this embodiment, the commodity-information presenting system 1 includes, as functional components for executing processing shown in FIGS. 12 to 16 explained later, the delivery-vehicle managing unit 210 of the head office server 21, the arrival-scheduled-time relay unit 410 of the store server 41, the display-scheduled-time managing unit 430 of the electronic-inventory-tag management server 43, and the display-date-and-time-display processing units 480 of the electronic inventory tag terminals 48.

The delivery-vehicle managing unit 210 of the head office server 21 includes an information transmitting and receiving unit 210a, a delivery-vehicle-information updating unit 210b, and an arrival-scheduled-time distributing unit 210c.

The information transmitting and receiving unit 210a receives delivery vehicle information including the information concerning the commodity code and the present location information transmitted from the delivery vehicle T. The information transmitting and receiving unit 210a receives a request signal requesting transmission of arrival scheduled time information (equivalent to “receipt time information” in claims) indicating arrival scheduled time from the store server 41 of each of the stores (1) to (N) and outputs the request signal to the delivery-vehicle-information updating unit 210b. The information transmitting and receiving unit 210a receives input of arrival scheduled time information from the arrival-scheduled-time distributing unit 210c explained later and transmits the input arrival scheduled time information to the store server 41.

The delivery-vehicle-information updating unit 210b includes a store-arrival-time calculating unit 210b-1 and a delivery-vehicle management table T1. The store-arrival-time calculating unit 210b-1 calculates, on the basis of the delivery vehicle information acquired via the information transmitting and receiving unit 210a, time information of time when the delivery vehicle T is supposed to arrive at each of the stores (1) to (N) (hereinafter also referred to as “arrival scheduled time information”) using a well-known technique such as map data and updates registered information of the delivery-vehicle management table T1 on the basis of the calculated arrival scheduled time information and the acquired delivery vehicle information.

More specifically, the store-arrival-time calculating unit 210b-1 has map data including detailed road information. The store-arrival-time calculating unit 210b-1 calculates information concerning arrival scheduled time of the delivery vehicle T at each of the stores (1) to (N) on the basis of, for example, the map data, road traffic information acquired from the outside, and the present location information of the delivery vehicle T included in the acquired delivery vehicle information.

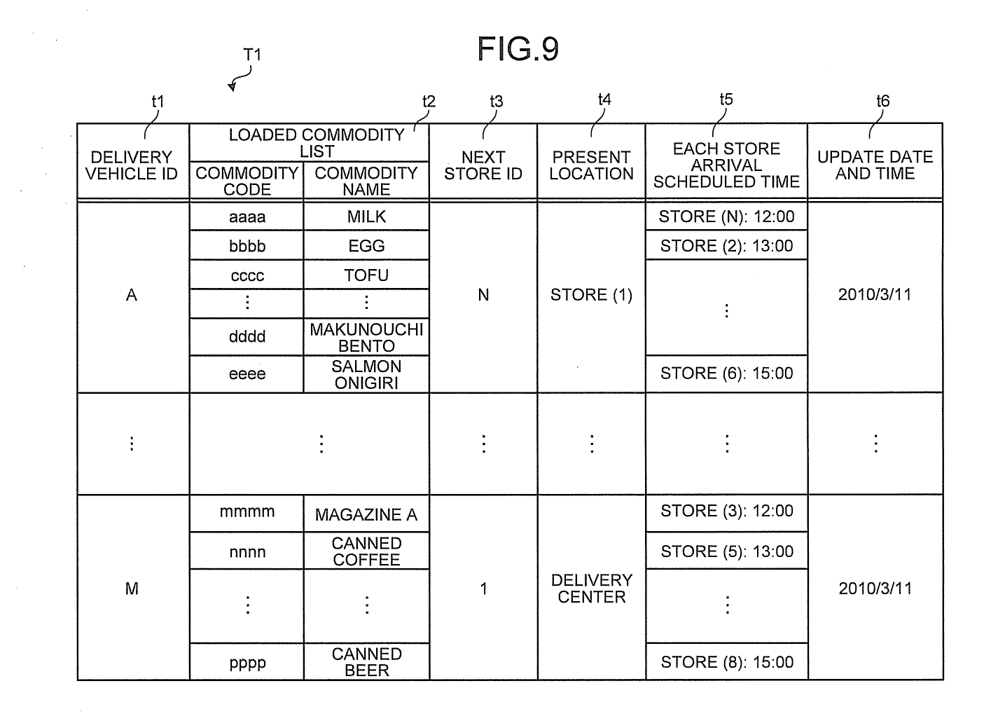

As shown in FIG. 9, the delivery-vehicle management table T1 includes a “delivery vehicle ID” item t1, a “loaded commodity list” item t2, a “next store ID” item t3, a “present location” item t4, an “each store arrival scheduled time” item t5, and an “update date and time” item t6. In the “delivery vehicle ID” item t1, identification information (ID) of the delivery vehicle T is registered. In the “loaded commodity list” item t2, a list of the commodities G loaded on the delivery vehicle T is registered. In the “next store ID” item t3, identification information (ID) of the next store to which the delivery vehicle T goes next is registered. In the “present location” item t4, the present location information of the delivery vehicle T is registered. In the “each store arrival scheduled time” item t5, arrival scheduled time information of time when the delivery vehicle T arrives at each store is registered. In the “update date and time” item t6, update date and time of this table is registered.

In an example shown in FIG. 9, the delivery-vehicle management table T1 indicates that, for example, the commodities G such as milks, eggs, tofu, Makunouchi Bento, and salmon onigiri are loaded on the delivery vehicle T having a delivery vehicle ID “A” by workers in the delivery center DC (see FIG. 1). The delivery-vehicle management table T1 also indicates that the present location of the delivery vehicle T having the delivery vehicle ID “A” is the store (1) and a store to which the delivery vehicle T goes next is the store (N) having a store ID “N”. The delivery-vehicle management table T1 also indicates that arrival scheduled time when the delivery vehicle T having the delivery vehicle ID “A” arrives at the store (N) is “12:00”, arrival scheduled time when the delivery vehicle T arrives at the store (2) is “13:00”, and arrival scheduled time when the delivery vehicle T arrives at the store (6) is “15:00”. The delivery-vehicle management table T1 also indicates that the update date and time is “2010/3/11”.

In other words, the delivery-vehicle-information updating unit 210b updates, on the basis of, for example, the vehicle ID, the information concerning loaded commodities, and the information concerning the present location included in the acquired delivery vehicle information and the information concerning the arrival scheduled time of arrival at each of the stores (1) to (N) calculated by the store-arrival-time calculating unit 210b-1, items of the delivery-vehicle management table T1 corresponding to the information.

The delivery-vehicle-information updating unit 210b also updates the item of the next store ID of the delivery-vehicle management table T1 on the basis of, for example, the information concerning the present location included in the delivery vehicle information, location information of the stores in the map data, and information concerning an ID list of the stores.

Referring back to FIG. 8, when the arrival-scheduled-time distributing unit 210c receives a request signal from the store server 41 of each of the stores (1) to (N) via the information transmitting and receiving unit 210a, the arrival-scheduled-time distributing unit 210c retrieves, according to a store ID and a commodity code included in the request signal, arrival scheduled time information of the store from the delivery-vehicle management table T1 and outputs the retrieved arrival scheduled time information to the information transmitting and receiving unit 210a.

The arrival-scheduled-time relay unit 410 of the store server 41 transfers the request signal from the electronic-inventory-tag management server 43 to the head office server 21. The arrival-scheduled-time relay unit 410 receives the arrival scheduled time information distributed by the arrival-scheduled-time distributing unit 210c and temporarily stores the information as arrival scheduled time information for management and transfers the received arrival scheduled time information to the electronic-inventory-tag management server 43.

The display-scheduled-time managing unit 430 of the electronic-inventory-tag management server 43 includes an information transmitting and receiving unit 430a, a display-scheduled-time updating unit 430b, a sold-out-commodity specifying unit 430c, and a commodity-information generating unit 430d.

The information transmitting and receiving unit 430a receives the arrival scheduled time information from the head office server 21 via the arrival-scheduled-time relay unit 410 of the store server 41 and outputs the arrival scheduled time information to the display-scheduled-time updating unit 430b.

The information transmitting and receiving unit 430a receives input of a request signal from an arrival-time requesting unit 430b-1 explained later and transmits the input request signal to the store server 41. The information transmitting and receiving unit 430a transmits commodity information input from the commodity-information generating unit 430d explained later to the electronic inventory tag terminal 48 corresponding to an inventory tag ID also input from the commodity-information generating unit 430d.

The display-scheduled-time updating unit 430b includes the arrival-time requesting unit 430b-1, a display-scheduled-time calculating unit 430b-2, and a display-scheduled-time management table T3. The display-scheduled-time calculating unit 430b-2 includes a past-result-display-time management table T2.

In the display-scheduled-time updating unit 430b, the display-scheduled-time calculating unit 430b-2 calculates, on the basis of the arrival scheduled time information acquired via the information transmitting and receiving unit 430a and registered information of the past-result-display-time management table T2 and updates registered information of the display-scheduled-time management table T3 on the basis of the calculated display scheduled time information.

More specifically, the display-scheduled-time calculating unit 430b-2 adds preparation time for each commodity set in advance in the past-result-display-time management table T2 to the acquired arrival scheduled time to calculate display scheduled time for each commodity.

If a predetermined request condition is satisfied, the arrival-time requesting unit 430b-1 generates a request signal requesting transmission of arrival scheduled time information and outputs the request signal to the information transmitting and receiving unit 430a. The predetermined request condition is satisfied, for example, when a request instruction signal including a commodity code of a sold-out commodity is input from the sold-out-commodity specifying unit 430c explained later or when predetermined request operation for requesting transmission of display scheduled time information by an operator on the store side is performed in the store server 41 or the electronic-inventory-tag management server 43. The request signal includes information concerning the store ID, the commodity code of the sold-out commodity, and the like.

In this embodiment, the arrival-time requesting unit 430b-1 transmits the request signal at every fixed period until supply of the sold-out commodity is completed.

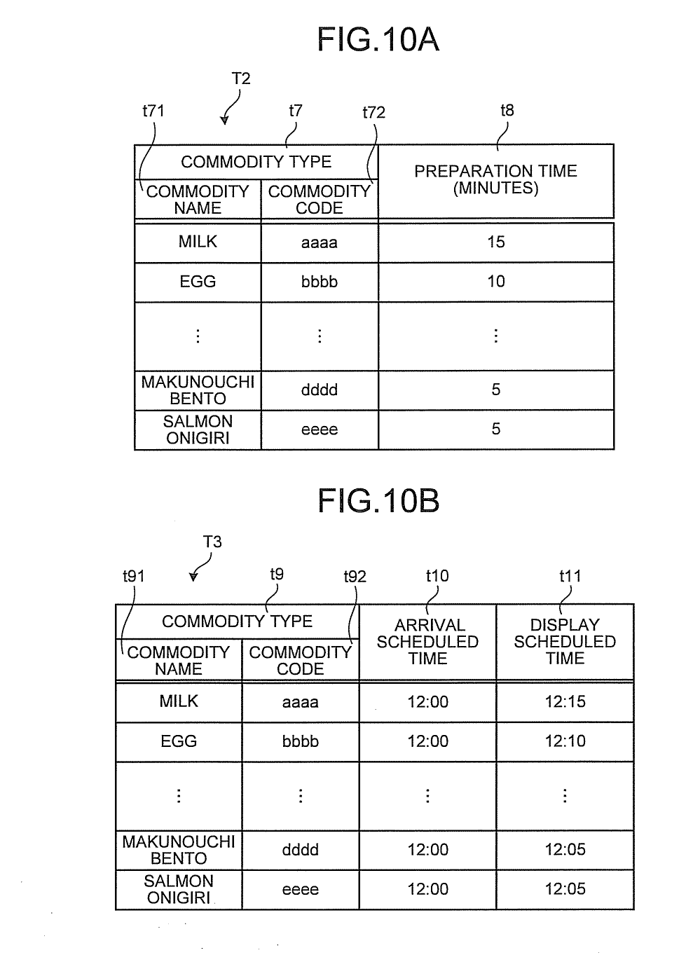

As shown in FIG. 10A, the past-result-display-time management table T2 manages preparation time for each commodity required until the commodities G are displayed in display places such as the shelf SH after the delivery vehicle T arrives at the store. The past-result-display-time management table T2 includes a “commodity type” item t7 indicating a type of the commodity and a “preparation time” item t8 indicating preparation time. The “commodity type” item t7 includes a “commodity name” item t71 indicating a name of the commodity and a “commodity code” item t72 indicating a commodity code of the commodity.

In an example shown in FIG. 10A, for example, preparation time “5 minutes” is associated with the commodity G having a commodity name “Makunouchi Bento” and a commodity code “dddd”. This indicates that the commodity G “Makunouchi Bento” is a commodity for which five minutes is necessary as preparation time until the commodity G is displayed in a display place such as the shelf SH (see FIG. 2) after the delivery vehicle T arrives at the store.

In the example shown in FIG. 10A, the preparation time is individually set for each commodity of one type. However, common preparation time may be set for commodities of all types.

As preparation time for the commodity G not requiring long time for display such as the commodity G that is displayed while being kept in a cardboard box for packaging for delivery, for example, “0 (minute)” is set.

As shown in FIG. 10B, the display-scheduled-time management table T3 is a table for managing registration of display scheduled time for each commodity calculated by the display-scheduled-time calculating unit 430b-2. The display-scheduled-time management table T3 includes a “commodity type” item t9 indicating a type of the commodity, an “arrival scheduled time” item t10 indicating arrival scheduled time of the commodity, and a “display scheduled time” item t11 indicating display scheduled time of the commodity. The “commodity type” item t9 includes a “commodity name” item t91 indicating a name of the commodity and a “commodity code” item t92 indicating a commodity code of the commodity.

In an example shown in FIG. 10B, for example, arrival scheduled time “12:00” and display scheduled time “12:05” are associated with the commodity having the commodity name “Makunouchi Bento” and the commodity code “dddd”. This indicates that the commodity G “Makunouchi Bento” is scheduled to arrive at the store at 12:00 and displayed in a predetermined display place such as the shelf SH (see FIG. 2) at 12:05.

For example, when the delivery vehicle T arrives at the store, the quantity of stock and the number of displayed items of the commodity G managed by the store server 41 or the electronic-inventory-tag management server 43 are updated by the operator on the store side or the like, and the quantity of stock and the number of displayed items in a sold-out-commodity management table T4 stored by the sold-out-commodity specifying unit 430c explained later are not zero (0), the display-scheduled-time updating unit 430b resets the arrival scheduled time and the display scheduled time of the display-scheduled-time management table T3. After this reset, the display-scheduled-time managing unit 430 causes the electronic inventory tag terminal 48 associated with the commodity G, the number of displayed commodities of which is not zero, to cancel the display of the display scheduled date and time information.

Referring back to FIG. 8, the sold-out-commodity specifying unit 430c includes the sold-out-commodity management table T4. The sold-out-commodity specifying unit 430c monitors, on the basis of the sold-out-commodity management table T4, whether there is a sold-out commodity, both the quantity of stock and the number of displayed items of which are zero (0). As a result of this monitoring, if there is a sold-out commodity, the sold-out-commodity specifying unit 430c outputs a request instruction signal including a commodity code of the sold-out commodity to the arrival-time requesting unit 430b-1.

When the display scheduled time is updated by the display-scheduled-time updating unit 430b, the sold-out-commodity specifying unit 430c retrieves an inventory tag ID of the electronic inventory tag terminal 48 associated with the commodity G corresponding to the display scheduled time. The sold-out-commodity specifying unit 430c retrieves, from the display-scheduled-time management table T3, display scheduled time information to be transmitted to the electronic inventory tag terminal 48 having the retrieved inventory tag ID. The sold-out-commodity specifying unit 430c outputs the retrieved display scheduled time information and the retrieved inventory tag ID to the commodity-information generating unit 430d.

In this embodiment, the store server 41 or the POS terminal 42 manages quantity-of-stock information indicating the quantities of stock of the commodities G of all types treated in the store and number-of-displayed-items information indicating the numbers of displayed items of the commodities G. The sold-out-commodity specifying unit 430c receives the quantity-of-stock information and the number-of-displayed-items information from the store server 41 or the POS terminal 42 and updates registered information of a sold-out commodity management table T4.

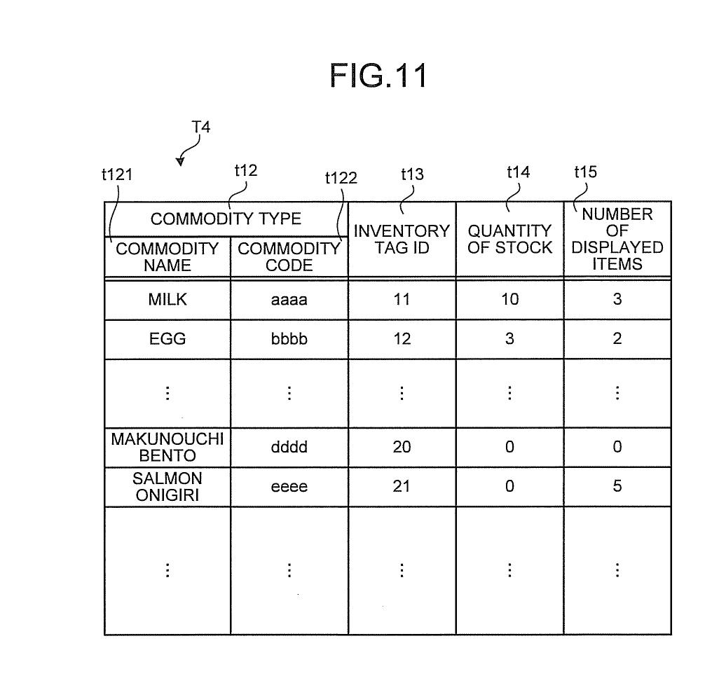

As shown in FIG. 11, the sold-out-commodity management table T4 manages the quantities of stock and the numbers of displayed items of the commodities G of all the types treated in the store. The sold-out-commodity management table T4 includes a “commodity type” item t12, an “inventory tag ID” item t13, a “quantity of stock” item t14, and a “number of displayed items” item t15. A type of the commodity G is registered in the “commodity type” item t12. An ID of the electronic inventory tag terminal 48 is registered in the “inventory tag ID” item t13. The quantity of stock of the commodity G stored in the backyard or the like of the store is registered in the “quantity of stock” item t14. The number of displayed items of the commodity G displayed in a display place such as the shelf SH (see FIG. 2) is registered in the “number of displayed items” item t15.

In an example shown in FIG. 11, for example, an inventory tag ID “20”, the quantity of stock “0”, the number of displayed items “0”, and the like are associated with the commodity having the commodity name “Makunouchi Bento” and the commodity code “dddd”. This indicates that the commodity G “Makunouchi Bento” is associated with the electronic inventory tag terminal 48 having the inventory tag ID “20” and both the quantity of stock and the number of displayed items of the commodity G is 0″.

The commodity-information generating unit 430d generates display scheduled date and time information of the sold-out commodity on the basis of the display scheduled time information input from the sold-out-commodity specifying unit 430c and date information acquired by a predetermined calendar function. The commodity-information generating unit 430d generates commodity information including the generated display scheduled date and time information and outputs the generated commodity information and the inventory tag ID to the information transmitting and receiving unit 430a.

The display-date-and-time-display processing unit 480 of the electronic inventory tag terminal 48 includes an information receiving unit 480a and a display-date-and-time display unit 480b.

The information receiving unit 480a receives commodity information including the display scheduled date and time information transmitted from the electronic-inventory-tag management server 43.

The display-date-and-time display unit 480b displays, on the basis of the display scheduled date and time information included in the commodity information received by the information receiving unit 480a, display scheduled date and time of the commodity G associated with the display-date-and-time display unit 480b on the display unit 48c (see, for example, FIG. 2).

The functional components (the delivery-vehicle managing unit 210, the arrival-scheduled-time relay unit 410, the display-scheduled-time managing unit 430, the display-date-and-time-display processing unit 480, etc.) explained with reference to FIG. 8 are realized by the control devices (the CPUs 211, 411, and 431 and the control unit 48a) of the apparatuses (the head office server 21, the store server 41, the electronic-inventory-tag management server 43, the electronic inventory tag terminal 48, etc.) expanding the computer programs P1 to P4 stored in the storage devices (the HDDs 214, 414, and 434, the storing unit 48b, etc.) on the RAMs 213, 413, and 433 and the storing unit 48b and executing the computer programs P1 to P4.

Details of various processing operations in the commodity-information presenting system 1 having the explained configuration are explained below.

As shown in FIG. 12, in this sequence, when the commodity G is loaded on the delivery vehicle T by the worker (Act 1) in the delivery center DC or every time a fixed period elapses after the loading (Act 2, etc.), the vehicle-information transmitting apparatus 6 mounted on the delivery vehicle T transmits delivery vehicle information including a commodity code of the loaded commodity G and the present location to the head office server 21 (Acts 3 and 4, etc.).

During the loading in Act 1, the worker inputs the commodity code of the loaded commodity G to the handy terminal (not shown). Then, the vehicle-information transmitting apparatus 6 acquires the commodity code from the handy terminal and transmits delivery vehicle information including the acquired commodity code to the head office server 21.

On the other hand, the head office server 21 calculates, every time the delivery vehicle information transmitted from the vehicle information transmission apparatus 6 of the delivery vehicle T is received, arrival scheduled time of arrival of the delivery vehicle T at each store and updates the registered information of the delivery-vehicle management table T1 (Acts 5 and 6).

On the other hand, in each of the stores (1) to (N), for example, when there is a sold-out commodity or when request operation is performed by the operator on the store side, the electronic-inventory-tag management server 43 transmits a request signal for arrival scheduled time information to the head office server 21 via the store server 41 (Act 7).

The head office server 21 that receives the request signal retrieves, on the basis of a store ID and a commodity code included in the request signal, arrival scheduled time information, which corresponds to the requesting store, of the delivery vehicle T that delivers the commodity G corresponding to the commodity code. The head office server 21 transmits the retrieved arrival scheduled time information to the store server 41 of the store (Act 8).

Then, the electronic-inventory-tag management server 43 receives the arrival scheduled time information via the store server 41 and calculates display scheduled time information of the sold-out commodity from the received arrival scheduled time information (Act 9). The electronic-inventory-tag management server 43 searches for the electronic inventory tag terminal 48 associated with the sold-out commodity (Act 10). The electronic-inventory-tag management server 43 transmits the display scheduled time information to the found electronic inventory tag terminal 48 (Act 11).

Then, the electronic inventory tag terminal 48 displays display scheduled date and time of the sold-out commodity on the display unit 48c on the basis of the received display scheduled time information (Act 12).

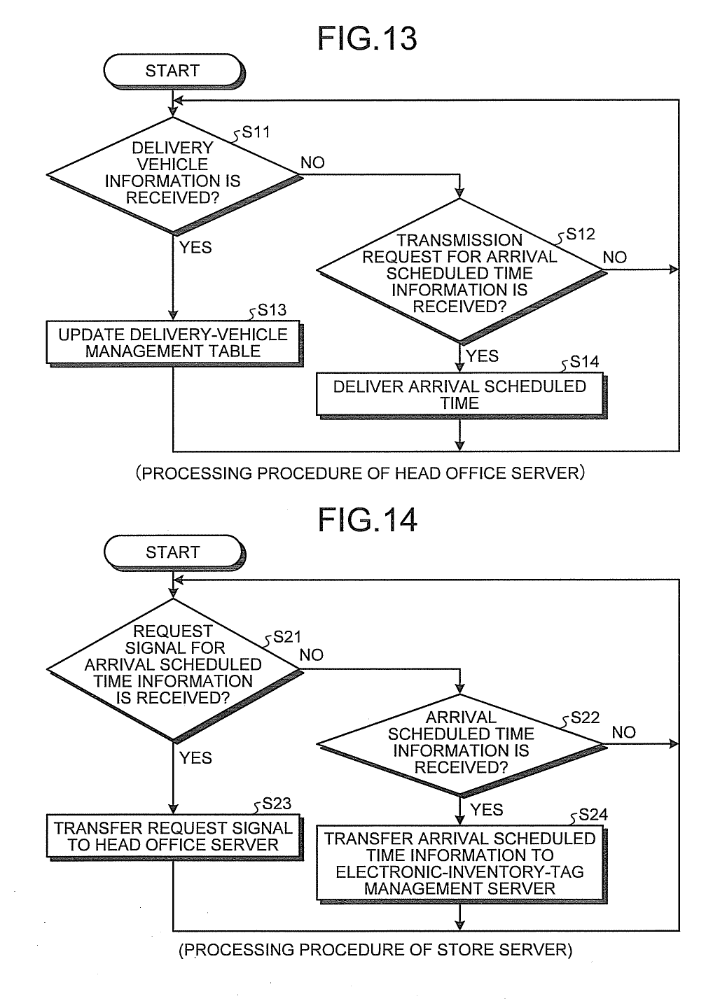

As shown in FIG. 13, in this processing, in Acts 11 and 12, the delivery-vehicle managing unit 210 monitors reception of delivery vehicle information from the vehicle-information transmitting apparatus 6 and reception of a request signal for arrival scheduled time information from the store server 41 or the electronic-inventory-tag management server 43. As a result of the monitoring, if the information transmitting and receiving unit 210a receives delivery vehicle information from the vehicle-information transmitting apparatus 6 (Yes in Act 11), subsequently, in Act 13, the delivery-vehicle-information updating unit 210b updates the delivery-vehicle management table T1.

Specifically, in the processing in Act 13, the store-arrival-time calculating unit 210b-1 calculates arrival scheduled time information in each of the stores (1) to (N) of the delivery vehicle T on the basis of present location information included in the delivery vehicle information received in Act 11, map data including road information, road traffic information acquired from the outside, and the like. The store-arrival-time calculating unit 210b-1 updates the registered information of the delivery-vehicle management table T1 on the basis of the received delivery vehicle information and the calculated arrival scheduled time.

Thereafter, the delivery-vehicle managing unit 210 returns the processing to Acts 11 and 12.

On the other hand, as a result of the monitoring, if the information transmitting and receiving unit 210a receives a request signal for arrival scheduled time from the store server (Yes in Act 12), subsequently, in Act 14, the arrival-scheduled-time distributing unit 210c retrieves, on the basis of a store ID and a commodity code included in the received request signal, arrival scheduled time information of a store corresponding to the store ID from the delivery-vehicle management table T1 and outputs the retrieved arrival scheduled time information to the information transmitting and receiving unit 210a. Then, the information transmitting and receiving unit 210a transmits the arrival scheduled time information to the store server 41.

As shown in FIG. 14, in this processing, in Acts 21 and 22, the arrival-scheduled-time relay unit 410 monitors reception of a request signal requesting transmission of arrival scheduled time information from the electronic-inventory-tag management server 43 and reception of arrival scheduled time information from the head office server 21. As a result of this monitoring, if the arrival-scheduled-time relay unit 410 receives a request signal for arrival scheduled time from the electronic-inventory-tag management server 43 (Yes in Act 21), subsequently, in Act 23, the arrival-scheduled-time relay unit 410 transfers the received request signal to the head office server 21.

On the other hand, as a result of the monitoring, if the arrival-scheduled-time relay unit 410 receives arrival scheduled time information from the head office server 21 (Yes in Act 22), subsequently, in Act 24, the arrival-scheduled-time relay unit 410 transfers the received arrival scheduled time information to the electronic-inventory-tag management server 43.

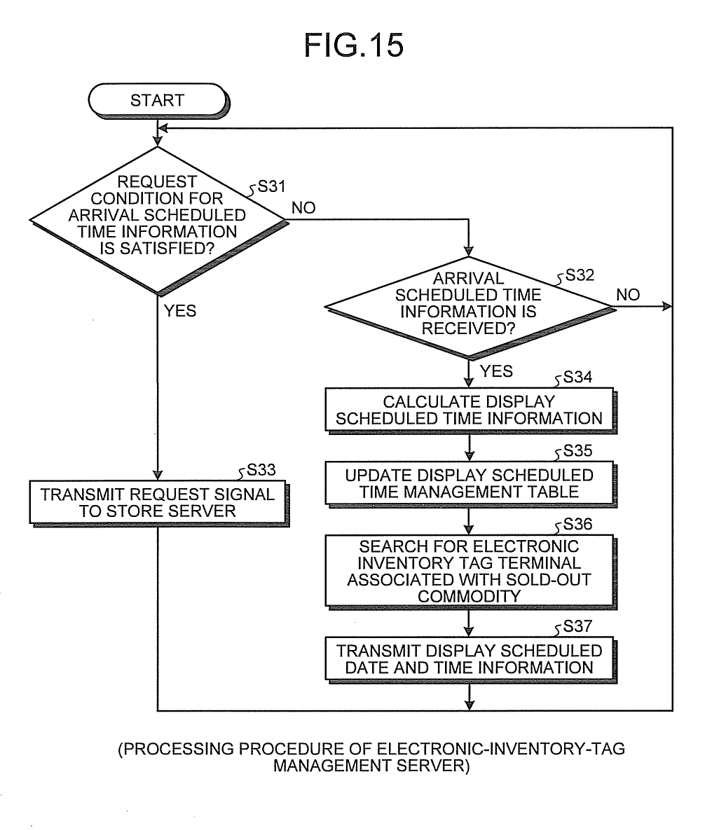

As shown in FIG. 15, in this processing, in Acts 31 and 32, the display-scheduled-time managing unit 430 monitors satisfaction of a requested condition of arrival scheduled time information and reception of arrival scheduled time information from the store server 41. As a result of this monitoring, if the display-scheduled-time managing unit 430 determines that a requested condition of arrival scheduled time information is satisfied (Yes in Act 31), subsequently, in Act 33, the arrival-time requesting unit 430b-1 generates a request signal for arrival scheduled time and outputs the request signal to the information transmitting and receiving unit 430a. Then, the information transmitting and receiving unit 430a transmits the request signal for arrival scheduled time to the store server 41.

On the other hand, as a result of the monitoring, if the information transmitting and receiving unit 430a receives arrival scheduled time information from the store server 41 (Yes in Act 32), subsequently, in Act 34, the display-scheduled-time calculating unit 430b-2 adds preparation time, which corresponds to the received arrival scheduled time information, retrieved from the past-result-display-time management table T2 to the arrival scheduled time information and calculates display scheduled time.

Subsequently, in Act 35, the display-scheduled-time updating unit 430b registers information concerning the display scheduled time calculated in Act 34 and the received arrival scheduled time information in the display-scheduled-time management table T3 and updates the registered information of the display-scheduled-time management table T3.

Subsequently, in Act 36, the sold-out-commodity specifying unit 430c searches for the electronic inventory tag terminal 48 associated with a sold-out commodity from the sold-out-commodity management table T4. In Act 37, the commodity-information generating unit 430d generates commodity information including display scheduled date and time information to be transmitted to the electronic inventory tag terminal 48 found in Act 36 and outputs the commodity information to the information transmitting and receiving unit 430a. Then, the information transmitting and receiving unit 430a transmits the commodity information including the display scheduled date and time information to the electronic inventory tag terminal 48.

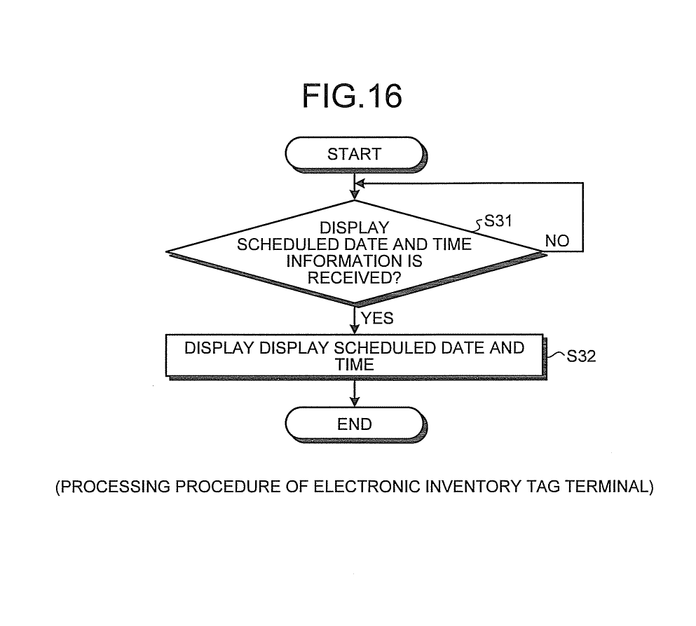

As shown in FIG. 16, in Act 31, the display-date-and-time-display processing unit 480 monitors reception of commodity information including display scheduled date and time information from the electronic-inventory-tag management server 43. As a result of this monitoring, if the information receiving unit 480a receives commodity information including display scheduled time information (Yes in Act 31) , subsequently, in Act 32, the display-date-and-time display unit 480b displays the commodity information including the display scheduled date and time on the display unit 48c on the basis of the commodity information received in Act 31.

According to the embodiment explained above, next display scheduled date and time of a sold-out commodity is displayed in the electronic inventory tag terminal 48 set in the store. Therefore, it is possible to appropriately present, to customers, display date and time when the sold-out commodity is displayed next.

With the configuration explained above, the problem in the past that customers go to other stores to find the sold-out commodity without waiting for a date of receipt can be eliminated. Therefore, it is possible to reduce a loss of sales opportunities and suppress a decrease in operating income of the store. Further, compared with stores that do not install the commodity-information presenting system 1 according to this embodiment, there is an effect that, in terms of convenience, sales opportunities increase and an increase in operating income of the store can be expected.

More specifically, since next display scheduled time of a sold-out commodity is presented to customers, depending on a customer, it can be expected that the customer looks around the other displayed commodities G, once returns to home or a company, or looks around other stores to adjust time taking into account store visiting time and the next display scheduled time displayed in the electronic inventory tag terminal 48 and, when the next display scheduled time comes, purchases the sold-out commodity. Therefore, it is possible to reduce a loss of sales opportunities and suppress a decrease in operating income of the store compared with the past.

According to this embodiment, unlike the past, it is unnecessary to take trouble to ask a store clerk about next display scheduled time of a sold-out commodity and therefore, convenience for customers is high.

The exemplary embodiment is explained above. However, embodiments are not limited to the embodiment explained above.

For example, in the mode explained in the embodiment, the display scheduled time added with the preparation time set in the arrival scheduled time in advance is displayed in the electronic inventory tag terminal 48. However, a mode is also possible in which the arrival scheduled time is directly displayed in the electronic inventory tag terminal 48 without the preparation time being added thereto or both the arrival scheduled time and the display scheduled time is displayed in the electronic inventory tag terminal 48.

In other words, a mode is also possible in which at least one of the arrival scheduled time and the display scheduled time is displayed.

In the mode explained in the embodiment, a commodity, both the quantity of stock and the number of displayed items of which are zero (0), is determined as a sold-out commodity and display scheduled time of the sold-out commodity is displayed in the electronic inventory tag terminal 48. However, besides, for example, a mode is also possible in which a commodity, the quantity of stock of which is zero (0) and the number of displayed items of which is smaller than a predetermined number (e.g., 5), is determined as a sold-out commodity and display scheduled time of the sold-out commodity is displayed in the electronic inventory tag terminal 48.

According to this mode, when a customer purchases a commodity with a short best before date (e.g., milk) , the customer can await time when the commodity is displayed next and purchase the commodity. Therefore, convenience for the customer is high.

Moreover, for example, a mode is also possible in which a commodity, the quantity of stock of which is not zero (0) and only the number of displayed items of which is zero (0), is determined as a sold-out commodity and display scheduled time of the sold-out commodity is displayed in the electronic inventory tag terminal 48. Specifically, for example, a mode is also possible in which it is notified to a store clerk or the like by the store server 41 or the electronic-inventory-tag management server 43 that the number of displayed items decreases to zero (0) and time obtained by adding the preparation time set in advance to time when the number of displayed items decreases to zero (0) is displayed in the electronic inventory tag terminal 48 as display scheduled time.

According to this mode, when a customer visits the store while there are commodities that are stocked but are not displayed and the commodities are not supplied and displayed by a store clerk, it is possible to prevent a situation in which a loss of sales opportunities occurs, for example, the customer notices that a desired commodity is not displayed on the shelf SH or the like and goes to other stores to find the commodity.

In the embodiment, for example, when there is a sold-out commodity or when request operation by the operator is performed, the store server 41 or the electronic-inventory-tag management server 43 requests the head office server 21 to transmit arrival scheduled time information. However, besides, for example, a mode is also possible in which, every time a fixed period elapses, the store server 41 or the electronic-inventory-tag management server 43 requests the head office server 21 to transmit arrival scheduled time information.

In the mode explained in the embodiment, the delivery vehicle T is mounted with the vehicle-information transmitting apparatus 6 including the navigation device 616 configured to specify the present location of the navigation device 616 using the satellite positioning system function. However, for example, a mode is also possible in which a communication apparatus having a function of specifying the present location of the communication apparatus using another well-known technique such as the triangulation is mounted on the delivery vehicle T.

In the mode explained in the embodiment, the head office server 21 acquires, from the vehicle-information transmitting apparatus 6 mounted on the delivery vehicle T, present location information of the delivery vehicle T and information (commodity codes) concerning the commodities G loaded on the delivery vehicle T. However, besides, for example, a mode is also possible in which the head office server 21 acquires these kinds of information from an information communication terminal carried by a person riding on the delivery vehicle T. Examples of the information communication terminal carried by the person riding on the delivery vehicle T include information communication terminals such as a cellular phone and a handy terminal having a code reading function for acquiring the commodity codes of the commodities G, a positioning system function for acquiring present location information of the information communication terminal, a function of transmitting the information acquired by the code reading function and the positioning system function, and the like. In this mode, a location acquisition service or the like provided by a communication carrier is used.

Besides the modes explained above, for example, a mode is also possible in which the person riding on the delivery vehicle T notifies, by making a call using a cellular phone or the like, an operator in the head office of present location information notified by the navigation device 616 mounted on the delivery vehicle T and commodity type information such as commodity codes and commodity names of the commodities G loaded on the delivery vehicle T and the operator manually inputs the present location information of the delivery vehicle T and the commodity type information to the head office server 21.

In the mode explained in the embodiment, if there is the commodity G, both the quantity of stock and the number of displayed items of which are zero (0) (case 1) or if request operation is performed by the operator (case 2), the store server 41 or the electronic-inventory-tag management server 43 requests the head office server 21 to transmit arrival scheduled time information. However, besides, for example, a mode is also possible in which, only in one of the case 1 and the case 2, the store server 41 or the electronic-inventory-tag management server 43 requests the head office server 21 to transmit arrival scheduled time.

In the mode explained in the embodiment, the vehicle-information transmitting apparatus 6 transmits the delivery vehicle information including the present location information of the delivery vehicle T and the commodity type information to the head office server 21. However, besides, for example, a mode is also possible in which a function of calculating time information of time of arrival at each store (arrival scheduled time information for each store) is provided in the navigation device 616 and the vehicle-information transmitting apparatus 6 transmits delivery vehicle information including the present location information of the delivery vehicle T, the commodity type information, and the arrival scheduled time information for each store calculated by the calculating function to the head office server 21.

In the mode explained in the embodiment, the electronic-inventory-tag management server 43 acquires the delivery vehicle information transmitted from the vehicle-information transmitting apparatus 6 of the delivery vehicle T via the head office server 21 and the store server 41. However, besides, for example, a mode is also possible in which the electronic-inventory-tag management server 43 acquires the delivery vehicle information not via both of or one of the head office server 21 and the store server 41.

In the embodiment, the information for specifying the commodity G loaded on the delivery vehicle T is the commodity code. However, besides, for example, the information only has to be information such as a commodity name with which a commodity can be specified.

In the mode explained in the embodiment, the electronic-inventory-tag management server 43 acquires the arrival scheduled time information for each store calculated by the head office server 21 that collectively manages stores. However, besides, for example, a mode is also possible in which the electronic-inventory-tag management server 43 acquires arrival scheduled time information for each store calculated by a server apparatus set on a communication carrier side.

In the embodiment, the quantity of stock and the number of displayed items of each of the commodities G are input by, for example, manual input in the store server 41 and the electronic-inventory-tag management server 43. However, besides, for example, a mode is also possible in which a sensor for detecting the number of displayed items or the like is provided and a value of the number of displayed items is updated according to a signal from the sensor.

The various computer programs P1 to P4 executed by the head office server 21, the store server 41, the electronic-inventory-tag management server 43, and the electronic inventory tag terminal 48 according to the embodiment may be provided while being recorded in a computer-readable recording medium such as a CD-ROM, a flexible disk (FD), a CD-R, a digital versatile disk (DVD), or a universal serial bus (USB) as a file of an installable format or an executable format or may be provided or distributed through a network such as the Internet.

Besides, the apparatus configuration and the functional configuration in the embodiment, the set values set in the various tables, and the like are described as mere examples.

What is claimed is:

1. An information processing apparatus comprising:
an input unit configured to receive input of receipt time information of a commodity;
a generating unit configured to generate, according to the receipt time information input to the input unit, commodity information concerning the commodity including at least one of receipt date and time information and display date and time information of the commodity; and
a transmitting unit configured to transmit the commodity information generated by the generating unit to an information display apparatus.

2. The apparatus according to claim 1, further comprising:
a storing unit configured to store preparation time information indicating preparation time until the commodity is displayed in a predetermined display place after the commodity is received in a store; and
a calculating unit configured to calculate display time of the commodity from the receipt time information and the preparation time information, wherein
the generating unit generates the commodity information including the display date and time information on the basis of the display time calculated by the calculating unit.

3. The apparatus according to claim 2, wherein the preparation time information stored in the storing unit is individually set for each commodity of one type.

4. The apparatus according to claim 2, wherein the preparation time information stored by the storing unit is commonly set for commodities of all types.

5. The apparatus according to claim 1, wherein the input unit receives the receipt time information transmitted from an information transmitting apparatus mounted on a delivery vehicle that delivers the commodity.

6. The apparatus according to claim 1, wherein
a plurality of the information display apparatuses are set in the store in association with commodities,
the generating unit generates the commodity information concerning a sold-out commodity, both a quantity of stock and a number of displayed items of which are zero, and
the transmitting unit transmits the commodity information of the sold-out commodity generated by the generating unit to the information display apparatus associated with the sold-out commodity.

7. The apparatus according to claim 1, wherein
a plurality of the information display apparatuses are set in the store in association with commodities,
the generating unit generates the commodity information concerning a sold-out commodity, a quantity of stock of which is zero and a number of displayed items of which is smaller than a predetermined number, and
the transmitting unit transmits the commodity information of the sold-out commodity generated by the generating unit to the information display apparatus associated with the sold-out commodity.

8. The apparatus according to claim 1, wherein
a plurality of the information display apparatuses are set in the store in association with commodities,
the generating unit generates the commodity information concerning a sold-out commodity, a quantity of stock of which is not zero and a number of displayed items of which is zero, and
the transmitting unit transmits the commodity information of the sold-out commodity generated by the generating unit to the information display apparatus associated with the sold-out commodity.

9. An information display apparatus comprising:
a receiving unit configured to receive commodity information concerning a commodity from an information processing apparatus; and
a display unit configured to display, on the basis of the commodity information received by the receiving unit, commodity information including at least one of receipt date and time information and display date and time information of the commodity.

10. A display control method comprising:
receiving input of receipt time information of a commodity;
generating, according to the input receipt time information, commodity information concerning the commodity including at least one of receipt date and time information and display date and time information of the commodity; and
transmitting the generated commodity information to an information display apparatus.
